(19) United States
(12) Patent Application Publication
(10) Pub. No.: US 2025/0082111 A1
(43) Pub. Date: Mar. 13, 2025

(54) INFLATABLE PAD

(71) Applicant: BESTWAY INFLATABLES & MATERIAL CORP., Shanghai (CN)

(72) Inventor: Xianglin ZENG, Shanghai (CN)

(21) Appl. No.: 18/665,342

(22) Filed: May 15, 2024

(30) Foreign Application Priority Data
Sep. 11, 2023 (CN) 202322464349.8

(51) Int. Cl. A47C 27/08; A47G 9/00; A47G 9/06; B32B 3/18; B32B 5/02; B32B 5/26; B32B 27/12

(52) U.S. Cl. CPC A47C 27/081; A47C 27/087; A47G 9/062; B32B 3/18; B32B 5/028; B32B 5/26; B32B 27/12; A47G 2009/003; B32B 2307/304; B32B 2307/718; B32B 2307/7376; B32B 2479/00

(57) ABSTRACT

The present disclosure provides an inflatable pad, the inflatable pad comprising: a top sheet; a bottom sheet connected to the top sheet to jointly define an inflatable chamber; an air valve; and at least one thermal insulation layer, the thermal insulation layer being an integral-piece batting-type sheet material, the thermal insulation layer being arranged in the inflatable chamber and welded to the top sheet and/or the bottom sheet along one or more welding regions. The inflatable pad according to the present disclosure facilitates mass production, has a good thermal insulation performance, and can also reduce noises when a user turns over, thereby improving comfort during use.

### CROSS REFERENCE TO RELATED APPLICATIONS

This Application claims priority from Chinese Application Number CN202322464349.8, filed Sep. 11, 2023 in China, the disclosure of which is incorporated herein by reference in its entirety for all purposes.

### FIELD AND BACKGROUND

### Field

The present disclosure generally relates to an inflatable pad, and in particular to an inflatable pad for wild camping.

### Description of the Related Art

During outdoor camping, campers often require a portable inflatable pad for thermal insulation and cushioning due to the cold and hard ground in the wild and a significant drop in temperature especially at night. Prior inflatable pads typically include a top sheet and a bottom sheet connected to each other to form an inflatable chamber. The inflatable pad has an important role in reducing heat transfer between the top sheet and the bottom sheet of the inflatable pad as much as possible. Typically, a human body sleeps on top of the top sheet of the inflatable pad, and the ground is located below the bottom sheet of the inflatable pad. If the inflatable pad can successfully prevent or significantly reduce the heat transfer between the top sheet and the bottom sheet (in other words, the inflatable pad has a good thermal insulation performance), to avoid the impact of low temperature of the ground on the human body, the human body can retain sufficient heat, thereby enjoying comfortable sleep and being adequately prepared for activities the next day. Inflatable pads with an excellent thermal insulation performance is expected by all campers, climbers, explorers, and hikers.

Fibrous insulation is known to provide a thermal insulation function. The insulation fibers may be formed into a batting-type sheet material in a fixed shape, and then the fixed shape may be subsequently placed in an inflatable pad, which can improve the thermal insulation performance of the inflatable pad, and can better preserve heat and prevent heat loss when a user sleeps on the inflatable pad at night. Such fibers may provide a softened feel that gently yields to pressure points from a body resting thereon, providing comfort to the user. In addition, fibrous insulation filler rarely makes noise, which is very beneficial for the user to fall asleep quickly and have a deep sleep without being disturbed by noise emanating from the inflatable pad during normal bodily movement.

A first type of commercially available existing inflatable pads contain fibrous insulation are usually formed by cutting a large piece of fibrous insulation batting into multiple small pieces, and then attaching the multiple small pieces of fibrous insulation onto the top sheet by glue, or attaching the multiple small pieces of fibrous insulation onto the bottom sheet by glue, or attaching the multiple small pieces of fibrous insulation onto the top sheet and the bottom sheet by glue at the same time, so as to fix the insulation pieces in predetermined positions and prevent the insulation pieces from sliding around in the finished inflatable pads later. For ease of the subsequent welding operation, there may be gaps between two adjacent small pieces of fibrous insulation. Then, the top sheet and the bottom sheet are welded together through the gaps between two adjacent small pieces of fibrous insulation.

A second type of commercially available inflatable pads utilize fibrous insulation, but differ from the first type of inflatable pads in that at the gaps between the multiple small pieces of fibrous insulation, instead of welding the top sheet and the bottom sheet directly, the top sheet and the bottom sheet are welded together by means of tensioning members. The presence of the tensioning members makes the thickness of the inflatable pad larger, which in turn causes an R-value to rise (the exact principle will be further described below). Therefore, the R-values of the second kind of insulation fiber inflatable pads are higher than those of the first kind of insulation fiber inflatable pads. However, the second type of inflatable pads still use multiple small pieces of fibrous insulation.

ASTM F3340-22 “Standard Test Method for Thermal Resistance of Camping Mattresses Using a Guarded Hot Plate Apparatus” is most widely used globally in the standardized test of thermal insulation performance of inflatable pads. Under the test method of ASTM F3340-22, a sample of an inflatable pad is inflated to a rated internal pressure and then placed between a guarded hot plate and a cold plate to be subjected to a constant compressive force. The hot plate is kept at 35° C., the cold plate is kept at 5° C., and the ambient temperature is controlled to be equal to the average temperature of the hot plate and the cold plate. The main heat transfer path of the test method is one-dimensional, and heat transfer is carried out through the vertical thickness of the inflatable pad. Under steady-state conditions, heat flux passing through the sample is measured, and the thermal resistance is calculated by dividing the temperature difference between the hot plate and the cold plate by the heat flux. After a series of conversions, the final thermal resistance is acquired, which is called as an R-value in ASTM F3340-22. The larger the R-value is, the better the thermal insulation performance of the inflatable pad is. The smaller the R-value is, the weaker the thermal insulation performance of the inflatable pad is. In the case where other conditions are the same, users usually prefer inflatable pads with large R-values and good thermal insulation performance.

An inflatable pad that does not include any filler inside and consists of only a top sheet and a bottom sheet typically has an R-value of 1.0 ft²·°F.·h/Btu (0.18 K·m²/W) to 1.5 ft²·°F.·h/Btu (0.26 K·m²/W) under the ASTM F3340-22 standard, e.g., 1.3 ft²·°F.·h/Btu (0.23 K·m²/W). The R-value under the ASTM F3340-22 standard of the inflatable pad (the first type of fibrous insulation inflatable pad) described above that comprises multiple small pieces of fibrous insulation between the top sheet and the bottom sheet may be larger than the R-value of the inflatable pad consisting of only the top sheet and the bottom sheet, e.g., within the range of 1.5 ft²·°F.·h/Btu (0.26 K·m²/W) to 2.0 ft²·°F.·h/Btu (0.35 Km²/W). In the case of the second type of commercially-available inflatable pad, which comprises multiple small pieces of fibrous insulation between the top sheet and the bottom sheet and in which the top sheet and the bottom sheet are connected by means of a tensioning member, such types of pads may have R-values that may be slightly higher than the first type of fibrous insulation inflatable pad.

The first type of fibrous insulation inflatable pads and the second type of fibrous insulation inflatable pads requires cutting a large piece of fibrous insulation batting into multiple small pieces of fibrous insulation, and attaching the multiple small pieces of fibrous insulation onto at least one of the top sheet and the bottom sheet by glue, which saves on some quantities of fibrous insulation, but leads to a low manufacturing efficiency, a high labor cost and long production time due to the required of the cutting and the gluing procedures.

In some approaches, fibrous insulation and a metal-plated film may be placed inside an inflatable pad together to improve the thermal insulation performance, but the metal-plated film may make a loud noise when a user turns over, moving and rubbing the top sheet, which in turn makes it difficult for a sound-sensitive user to fall asleep at night. Further, foam may be used as insulation instead of fibrous insulation, but often large chunks of foam are placed inside the inflatable pad when a foam-containing inflatable pad is made, resulting in a significant increase in the weight of a mattress. Users who enjoy hiking and are sensitive to lightweight features are often reluctant to buy heavier foam-containing inflatable pads. Therefore, how to increase the R-value of the inflatable pad with only quiet and lightweight insulation materials has been a technical challenge in the industry.

### SUMMARY

Example embodiments may address at least the above problems and/or disadvantages and other disadvantages not described above. Also, example embodiments are not required to overcome the disadvantages described above, and may not overcome any of the problems described above.

The following summary of the invention is exemplary and explanatory only and is not necessarily restrictive of the invention as claimed. The summary is intended to present general aspects of the present invention in order to provide a basic understanding of at least some features of the invention. This summary is not an extensive overview of the invention. It is not intended to identify key or critical elements of the invention or to delineate the scope of the invention. The following summary merely presents some concepts of the invention in a general form as a prelude to the more detailed description provided below. Example embodiments may address at least the above problems and/or disadvantages and other disadvantages not described above. Also, example embodiments are not required to overcome the disadvantages described above, and may not overcome any of the problems described above.

Further, it should be noted that in various embodiments, description is made with reference to figures, in which like reference numerals refer to similar or identical items in the drawings, unless otherwise indicated herein. However, certain embodiments may be practiced without one or more of these specifically identified details, or in combination with other known methods and configurations. In the following summary and detailed description, numerous details are set forth, such as specific configurations, dimensions and processes, etc., in order to provide a thorough understanding of the present invention. In other instances, well-known processes and conventional hardware have not been described in particular detail in order to not unnecessarily obscure the present invention. Reference throughout this specification to “one embodiment,” “an embodiment” or the like means that a particular feature, structure, configuration, or characteristic described in connection with the embodiment is included in at least one embodiment of the invention. Thus, the appearances of the phrase “in one embodiment,” “an embodiment,” or the like in various places throughout this specification are not necessarily referring to the same embodiment of the invention. Furthermore, the particular features, structures, configurations, or characteristics may be combined in any suitable manner in one or more embodiments.

An objective of the present disclosure is to provide an improved inflatable pad that provides improved insulation performance, overall light weight, and improved manufacturability.

For this purpose, the present disclosure provides an inflatable pad, the inflatable pad comprising: a top sheet; a bottom sheet connected to the top sheet to jointly define an inflatable chamber; an air valve; and at least one thermal insulation layer, the thermal insulation layer being an integral-piece batting-type sheet material, the thermal insulation layer being arranged in the inflatable chamber and welded to the top sheet and/or the bottom sheet along a plurality of welding regions. It should be noted that the terms “top sheet” and “bottom sheet” that are used throughout this application are not necessarily intended to limit the assembly of the inflatable pad or positional orientations therefor, and the inflatable pad may be assembled or used in any desired manner such as a configuration with the top sheet facing a substantially upward direction and the bottom sheet facing a substantially downward direction, or in a configuration where the bottom sheet is facing a substantially upward direction and the top sheet is facing a substantially downward direction.

Compared with an inflatable pad using a disconnected thermal insulation layer in the prior art, the inflatable pad according to the various embodiments herein comprises a batting-type integral-piece thermal insulation layer being arranged in the inflatable chamber formed by the top sheet and the bottom sheet. In an embodiment, the integral-piece thermal insulation layer material may be connected to the top sheet or the bottom sheet. In another embodiment, two integral-piece thermal insulation layer materials may be connected to the top sheet and the bottom sheet, respectively. In various embodiments, the thermal insulation layer extends parallel to the top and/or bottom sheet. The thermal insulation layer may extend over more than 90% of the surface area of the top sheet or the bottom sheet, respectively. In embodiments, the thermal insulation layer may extend over more than 95% of the surface area of the top sheet or the bottom sheet, respectively. In embodiments, the thermal insulation layer may extend over more than 98% of the surface area of the top sheet or the bottom sheet, respectively. In another embodiment, the thermal insulation performance of the inflatable pad is enhanced, heat convection between the top and the bottom of the inflatable pad is reduced, and the R-value is improved.

Furthermore, compared with prior art inflatable pads using a disconnected thermal insulation layer, in various embodiments, thermal insulation layers may be affixed more firmly and thus less likely to fall off. Due to the thermal insulation layers being connected to the top sheet and the bottom sheet of the product for example by means of high-frequency welding, hot-press welding, etc. without cutting the fibrous insulation or making holes in the fibrous insulation and without attaching the fibrous insulation onto the top sheet or the bottom sheet by glue, the inflatable pad according to the various embodiments herein has fewer manufacturing processes, and is efficient to manufacture, less expensive in terms of labor costs, and faster to assemble in production than prior art designs.

According to the above technical concept, the present disclosure may further comprise one or more of the following embodiments.

An inflatable pad may comprise: a top sheet; a bottom sheet connected to the top sheet to jointly define an inflatable chamber; an air valve; and at least one thermal insulation layer, wherein each of the at least one thermal insulation layer is an integral-piece batting-type sheet material, and is arranged between the top sheet and the bottom sheet, and welded to the top sheet and/or the bottom sheet along one or more welding regions.

In some embodiments, at least one of the top sheet and the bottom sheet comprises an outer layer facing away from the inflatable chamber and an inner layer facing towards the inflatable chamber, the outer layer being a fabric layer, and the inner layer being made of a polymer material.

In some embodiments, the fabric layer comprises one or more of cotton fiber, wool fiber, silk fiber, hemp fiber, regenerated fiber, polyester fiber, polyamide fiber, polyacrylonitrile fiber, polyvinyl alcohol fiber, polypropylene fiber, polyurethane fiber, or inorganic fiber.

In some embodiments, the polymer material comprises one or more of polyvinyl chloride, thermoplastic polyurethane elastomer, polyurethane, polypropylene, polyethylene, polyethylene terephthalate, polyamide, or nylon.

In some embodiments, the thermal insulation layer is made of fibrous insulation.

In some embodiments, the at least one thermal insulation layer is made of at least one or more of insulating fiber, cotton fiber, wool fiber, viscose fiber, acetate fiber, polyester fiber, polyamide fiber, polyacrylonitrile fiber, polyvinyl alcohol fiber, polypropylene fiber, or polyurethane fiber.

In some embodiments, the inflatable pad further comprises at least one connecting sheet, the connecting sheet being arranged in the inflatable chamber and welded between the top sheet and the at least one thermal insulation layer or between the bottom sheet and the at least one thermal insulation layer along the one or more welding regions.

In some embodiments, the connecting sheet is made of at least one of: polyvinyl chloride, thermoplastic polyurethane elastomer, polyurethane, polypropylene, polyethylene, polyethylene terephthalate, polyamide, or nylon; a fabric bonding material; or a laminated mesh material.

In some embodiments, the connecting sheet has a thickness of 0.04 mm to 0.10 mm, and the top sheet and/or the bottom sheet comprise(s) a polymer material layer welded to the connecting sheet, the polymer material layer having a thickness of 0.04 mm to 0.18 mm.

In some embodiments, the inflatable pad further comprises one or more tensioning members connecting the top sheet to the bottom sheet, the one or more tensioning members each being welded to the at least one thermal insulation layer and the top sheet and/or the bottom sheet along the one or more welding regions. In another aspect, the one or more tensioning members may be simultaneously welded to the at least one thermal insulation layer and the top sheet and/or the bottom sheet along the one or more welding regions.

In some embodiments, each of the one or more tensioning members comprises polyvinyl chloride, thermoplastic polyurethane elastomer, polyurethane, polypropylene, polyethylene, polyethylene terephthalate, polyamide, or nylon, or a fabric bonding material or a laminated mesh material.

In some embodiments, the inflatable pad may further comprise a connecting sheet, the connecting sheet being arranged between the top sheet and the at least one thermal insulation layer and/or between the bottom sheet and the at least one thermal insulation layer so that the at least one thermal insulation layer is welded between the connecting sheet and the one or more tensioning members.

In some embodiments, the one or more tensioning members comprise one or more of: a C-shaped cross-sectional profile; a Z-shaped cross-sectional profile; a continuous truss-shaped cross-sectional profile; a polygonal cross-sectional profile having two welding regions; a polygonal cross-sectional profile having four welding regions; and a main body including one or more perforations.

In some embodiments, the inflatable pad further comprises a side wall, a periphery of the top sheet is connected to a top edge of the side wall, and a periphery of the bottom sheet is connected to a bottom edge of the side wall, such that the top sheet, the bottom sheet and the side wall jointly define the inflatable chamber.

In some embodiments, the one or more welding regions comprises a plurality of welding points and/or a plurality of welding lines distributed uniformly.

In some embodiments, the inflatable pad comprises a single thermal insulation layer, the single thermal insulation layer being directly welded to the top sheet and the bottom sheet.

In some embodiments, each of the top sheet and the bottom sheet comprises a polymer material layer welded to the single thermal insulation layer, the polymer material layer having a thickness of 0.08 mm to 0.28 mm.

In some embodiments, the inflatable pad comprises a first thermal insulation layer welded to the top sheet and a second thermal insulation layer welded to the bottom sheet.

In some embodiments the inflatable pad in an inflated state has a height of 2 cm to 62 cm.

In some embodiments the inflatable pad in an inflated state has a height of 5 cm to 18 cm.

In some embodiments, the thermal insulation layer has a weight in the range of 20 g/m² to 400 g/m².

In some embodiments, the thermal insulation layer has a weight in the range of 80 g/m² to 160 g/m².

In some embodiments, the thermal insulation layer has a thickness in the range of 0.5 cm to 3 cm in a natural fluffy state.

In some embodiments, the thermal insulation layer has a thickness in the range of 0.8 cm to 2 cm in a natural fluffy state.

In an alternate embodiment an inflatable pad comprises
a top sheet, a bottom sheet, and a connecting sheet arranged between the top sheet and the bottom sheet; a thermal insulation layer arranged between the top sheet and the connecting sheet, wherein the thermal insulation layer is an integral-piece batting-type sheet material, the thermal insulation layer being welded to at least the top sheet proximate a peripheral weld zone; one or more tensioning members connecting the connecting sheet to the bottom sheet, each of the plurality of tensioning members being welded to the connecting sheet and the bottom sheet along a plurality welding regions; and wherein the bottom sheet is connected to the connecting sheet proximate the peripheral weld zone to jointly define an inflatable chamber, an air valve further provided in fluid communication with the inflatable chamber to allow for inflation or deflation thereof.

An inflatable pad according to the present embodiments facilitates mass production, is lightweight, has good thermal insulation performance, and can also provide for reduced noise when a user moves or turns over while sitting or lying on the inflatable pad, thereby improving comfort during use.

### BRIEF DESCRIPTION OF THE DRAWINGS

Other features and advantages of the present disclosure will be better understood from the following optional embodiments described in detail with reference to the accompanying drawings, in which like reference numerals represent the same or similar components.

FIG. 1 is a schematic perspective diagram of an inflatable pad according to a first embodiment;

FIG. 2A is a schematic perspective partially-resected diagram of the inflatable pad according to the first embodiment;

FIG. 2B is a schematic enlarged diagram of a partially-resected portion of FIG. 2A;

FIG. 3 is a partial schematic cross-sectional diagram of the inflatable pad according to the first embodiment;

FIG. 4 is a partial schematic cross-sectional diagram of an inflatable pad according to a second embodiment;

FIG. 4A is a partial schematic cross-sectional diagram of an inflatable pad according to a third embodiment;

FIG. 4B is a partial schematic cross-sectional diagram of an inflatable pad according to an eighth embodiment;

FIG. 4C is a partial schematic perspective view of an embodiment of a tensioning member of the present invention;

FIG. 4D shows a partial cross-sectional view of layers comprising a top sheet of the present invention;

FIG. 4E shows a partial cross-sectional view of layers comprising a bottom sheet of the present invention;

FIG. 5 is a schematic exploded diagram of the inflatable pad according to the second embodiment;

FIG. 6 is a schematic exploded diagram of an inflatable pad according to a fourth embodiment;

FIG. 7 is a schematic exploded diagram of an inflatable pad according to a fifth embodiment;

FIG. 8 is a schematic exploded diagram of an inflatable pad according to a sixth embodiment;

FIG. 9 is a schematic perspective diagram of an inflatable pad according to a seventh embodiment;

FIG. 10 is a schematic exploded diagram of the inflatable pad according to the seventh embodiment; and

FIG. 11 is a schematic exploded diagram of an inflatable pad according to a ninth embodiment.

It can be understood that the accompanying drawings are not only intended to explain and illustrate the present disclosure, but also contribute to the definition of the present disclosure if necessary.

### DETAILED DESCRIPTION

The implementation and application of the embodiments will be discussed in detail below. However, it can be understood that the specific embodiments discussed herein only illustratively describe the specific implementation and application of the present disclosure, but are not intended to limit the scope of the present disclosure.

In the description, the expressions indicating orientations such as upper, lower, top, bottom, etc., which are used for describing the structural positions of various components, are not absolute but relative. The expressions indicating orientations are appropriate when the various components are arranged as shown in the figures, but should change accordingly when the positions of the components in the figures change.

In the description, unless expressly stated or limited otherwise, the terms such as “fixing”, “connection”, “connected”, etc. should be interpreted broadly, for example, either fixed or detachable connection, or integration; or may be a direct connection or an indirect connection by means of an intermediate medium, or may be communication between interiors of two elements or interaction between the two elements. For those skilled in the art, the specific meaning of the above terms in the description would have been understood according to specific circumstances.

### First Embodiment

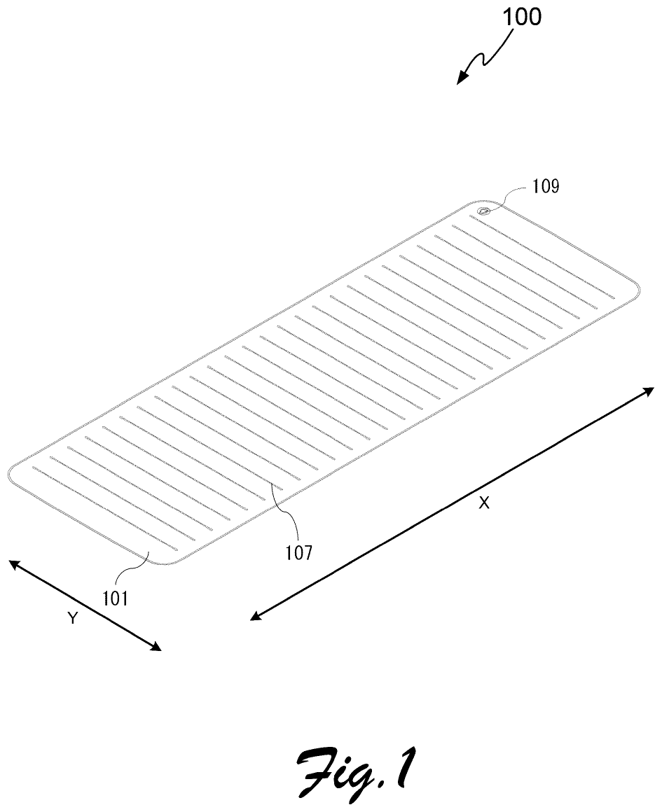

FIG. 1 to FIG. 3 show an inflatable pad 100 according to a first embodiment of the present disclosure and components thereof.

Referring to FIG. 1, in the illustrated embodiment, the large planar surfaces of the assembled inflatable pad 100 are substantially rectangular in form, having a long horizontal axis along the X direction and a short horizontal axis along the Y direction. Those of skill in the art appreciate that the shape of the inflatable pad 100 as set forth herein is not limited to the illustrated embodiments. In some other implementation variants, the inflatable pad 100 may also assume other appropriate shapes, such as a substantially oval shape, a mummy shape, a trapezoidal shape, a round shape, and a substantially conical shape.

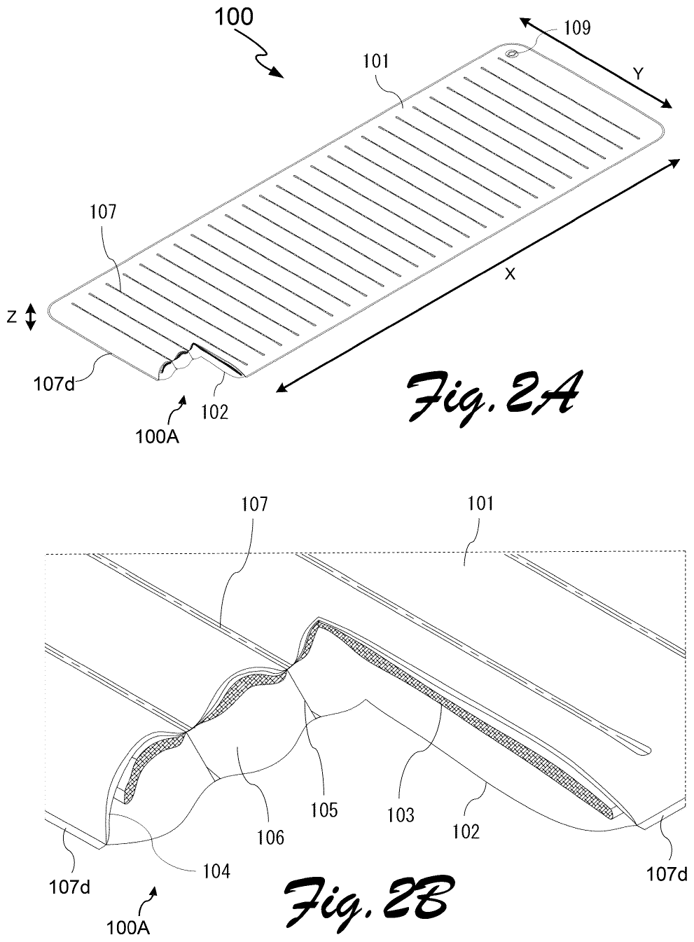

Referring to FIGS. 2A, 2B and 3-5, the inflatable pad 100 comprises a top sheet 101, and a bottom sheet 102 jointly defining an inflatable chamber 106 therebetween, including an air valve 109, and at least one thermal insulation layer 103 disposed between the top sheet 101 and the bottom sheet 102. In FIG. 2A, the inflatable pad 100 is shown in inflated configuration, with a corner section 100A shown removed and further enlarged in FIG. 2B to illustrate details of the internal layer configuration of the inflatable pad 100. The inflatable pad 100 may optionally additionally comprise a connecting sheet 104, and/or a plurality of tensioning members 105.

The periphery of the top sheet 101 and the periphery of the bottom sheet 102 are, for example, connected to each other at a peripheral weld zone 107d through a gas-impermeable bond such as welding, etc., jointly defining the inflatable chamber 106 therebetween. The top sheet 101 may be configured to accommodate a user in a sitting or prone position, and the bottom sheet 102 may be configured to engage with a supportive surface such as a floor, the ground, or a tent bottom. The top sheet 101 and the bottom sheet 102 may comprise substantially the same shape and dimension. The top sheet 101 and the bottom sheet 102 may be substantially parallel. An air valve 109 may be attached onto or within the top sheet 101, for instance by welding the air valve 109, and may be disposed adjacent to a side edge of the inflatable pad 100 as shown in the referenced figures. In an alternative embodiment, the air valve 109 may be attached onto or within the bottom sheet 102, for instance, by welding to the bottom sheet 102. The position of the air valve 109 is not limited in the present disclosure. The air valve may be an electric air valve or a non-electric air valve.

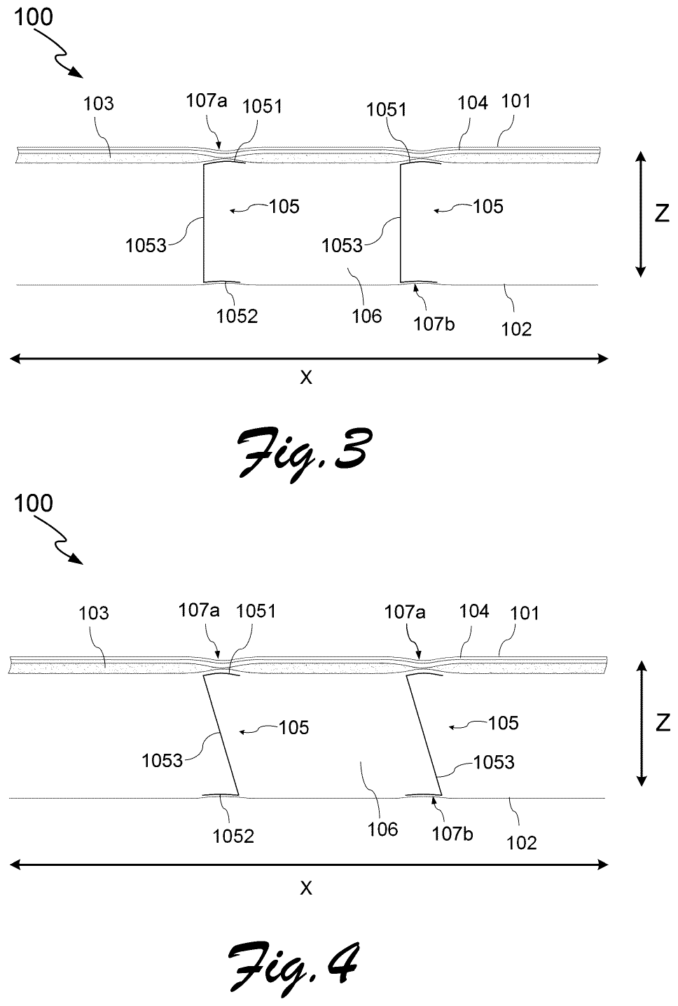

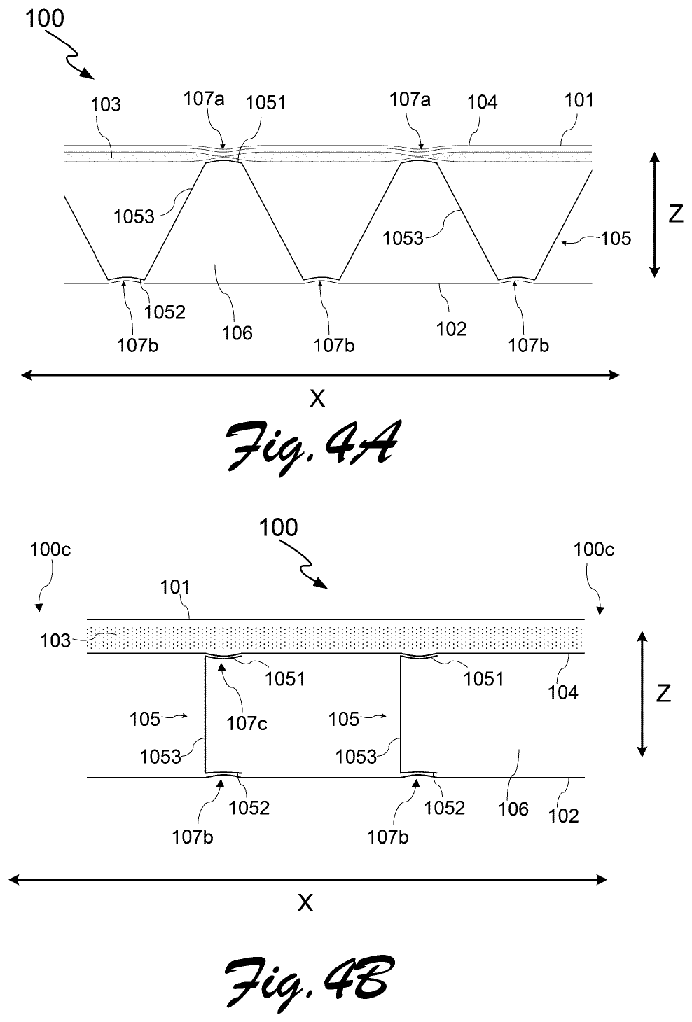

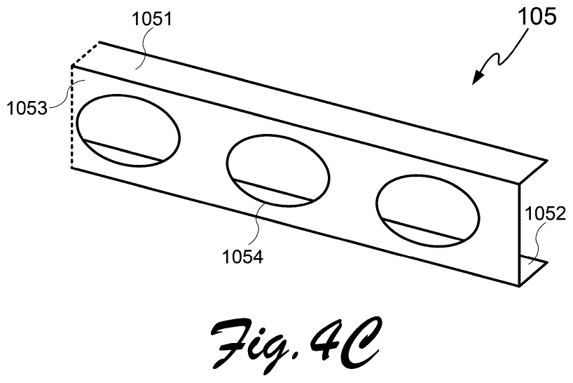

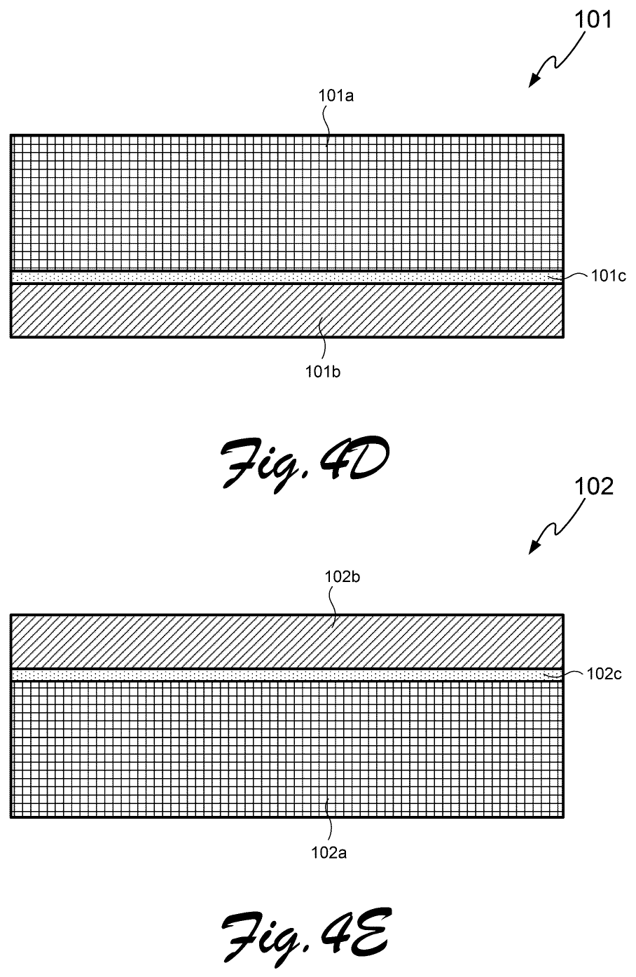

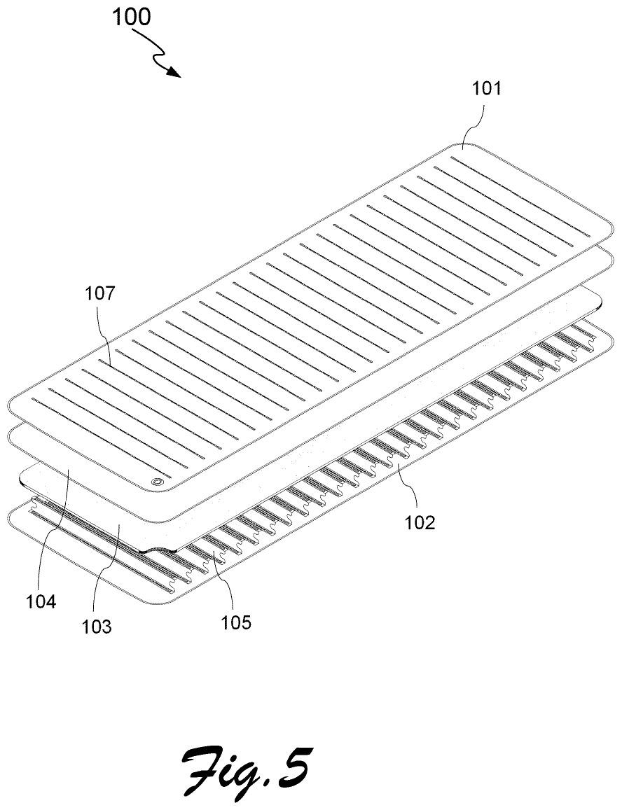

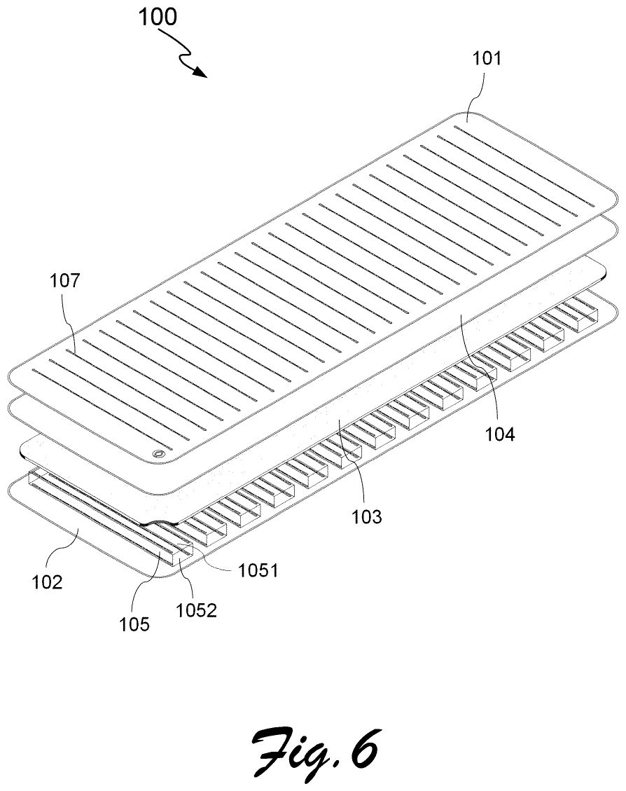

In an example embodiment further shown in the partial cross-sectional drawings of FIGS. 4D-4E, the top sheet 101 comprises a top outer layer 101a oriented upwards away from the inflatable chamber 106 and a top inner layer 101b oriented downwards towards the inflatable chamber 106. In one aspect, the top outer layer 101a comprises a fabric layer configured to provide comfortable support to a human body, and the top inner layer 101b may be formed from weldable material. The top inner layer 101b may comprise a polymer material layer. The fabric layer may comprise one or more of cotton fiber, wool fiber, silk fiber, hemp fiber, regenerated fiber, polyester fiber, polyamide fiber, polyacrylonitrile fiber, polyvinyl alcohol fiber, polypropylene fiber, polyurethane fiber and inorganic fiber. The polymer material layer may comprise one or more of polyvinyl chloride (PVC), thermoplastic polyurethane elastomer (TPU), polyurethane (PU), polypropylene (PP), polyethylene (PE), polyethylene terephthalate (PET), nylon and other suitable polymer materials. The fabric of the top outer layer 101a may be attached to and/or laminated to the top inner layer 101b through the adhesive layer 101c. As shown in FIG. 4E, the bottom sheet 102 may comprise a similar structure as the top sheet 101, i.e., the bottom sheet 102 may comprise an outer layer 102a oriented downwards and away from the inflatable chamber 106 and an bottom inner layer 102b oriented upwards towards the inflatable chamber 106. The outer layer 102a may comprise, for example, a fabric layer made of the material described above, and the bottom inner layer 102b may comprise, for example, a polymer layer made of the material described above, so that the user of the inflatable pad 100 may sit, recline, or sleep on either side of the inflatable pad 100. As with the top sheet 101, a fabric layer comprising the outer layer 102a may be attached to or laminated to the bottom inner layer 102b through adhesive layer 102c. Optionally, the bottom sheet 102 may comprise a different structure than the top sheet 101, for example, the bottom sheet 102 may comprise a single polymer material layer. The polymer material inner layer 101b of the top sheet 101 may have a thickness of 0.04 mm to 0.18 mm, for example, about 0.06 mm. The polymer material inner layer 102b of the bottom sheet 102 may have a thickness of 0.04 mm to 0.18 mm, for example, about 0.06 mm.

A thermal insulation layer 103 may be arranged in the inflatable chamber 106. In an embodiment, also a connecting sheet 104 may be arranged in the inflatable chamber 106. However, aspects of the present embodiments are not limited thereto. The thermal insulation layer 103 may be of substantially the same shape and dimension as the top sheet 101 and the bottom sheet 102. In embodiments, the thermal insulation layer 103 extends parallel to and is disposed between the top and/or bottom sheet. The thermal insulation layer 103 may extend over more than 90% of the surface area of the at least one of the top sheet or the bottom sheet 101, 102, respectively. In embodiments, the thermal insulation layer 103 may extend over more than 95% of the surface area of the at least one of the top sheet 101 or the bottom sheet 102, respectively. In embodiments, the thermal insulation layer 103 may extend over more than 98% of the surface area of the at least one of the top sheet 101 or the bottom sheet 102, respectively. In one aspect, thermal insulation layer 103 comprises an integral-piece thermal insulation layer and is in the form of a fibrous batting-type sheet material. The batting-type sheet material may be soft and fluffy. In another embodiment, the batting-type sheet material may offer cushioned support. According to the present disclosure, the thermal insulation layer 103 is preferably made of fibrous insulation. For example, the thermal insulation layer 103 is made of one or a combination of more of cotton fiber, wool fiber, viscose fiber, acetate fiber, polyester fiber (especially polyethylene terephthalate (PET) fiber), polyamide fiber, polyacrylonitrile fiber, polyvinyl alcohol fiber, polypropylene fiber and polyurethane fiber. The connecting sheet 104 may be provided to improve the connection between the thermal insulation layer 103 and the top or bottom sheets 101, 102. The connecting sheet 104 may be designed to have a melting point that is lower than that of the top inner layer 101b of the top sheet 101 and/or the bottom inner layer 102b of bottom sheet 102, respectively. Consequently, during the welding process, as the temperature increases, the connecting sheet 104 melts before the top inner layer 101b of the top sheet 101 and/or the bottom inner layer 102b of bottom sheet 102. This facilitates the fusion of the thermal insulation layer 103 with the top inner layer 101b of top sheet 101 and/or the bottom inner layer 102b of bottom sheet 102, thereby increasing the welding strength. Additionally, the connecting sheet 104 melting before the top inner layer 101b of the top sheet 101 and/or the bottom inner layer 102b of bottom sheet 102 helps protect the integrity of the top sheet 101 and/or bottom sheet 102, preventing air leakage in the inflatable pad caused by the melting of the top inner layer 101b of the top sheet 101 and/or the bottom inner layer 102b of bottom sheet 102, respectively.

However, in various embodiments, the connecting sheet 104 can also be omitted. If used, the connecting sheet 104 may be of substantially the same shape and dimension as the top sheet 101, the bottom sheet 102 and the thermal insulation layer 103. For example, the connecting sheet 104 may comprise the same or similar material as the inner layer of the top sheet 101. For example, the connecting sheet 104 may comprise weldable material. The connecting sheet 104 may comprise one or more of polyvinyl chloride (PVC), thermoplastic polyurethane elastomer (TPU), polyurethane (PU), polypropylene (PP), polyethylene (PE), polyethylene terephthalate (PET), nylon and other suitable polymer materials. Optionally, the connecting sheet 104 may comprise a fabric bonding material and/or a laminated mesh material. The term “fabric bonding material” may refer to a double-layer material formed by bonding the fabric layer as set forth above to the polymer material layer as set forth above, and the term “laminated mesh material” may refer to a three-layer material formed by bonding the two polymer material layers as set forth above to the fabric layer as set forth above, which in in turn sandwiched therebetween. In the illustrated embodiment, the periphery of the connecting sheet 104 is for example connected to the periphery of the top sheet 101 and the periphery of the bottom sheet 102 through welding or other attachment technique. According to an implementation variant, there may be a gap between the periphery of the connecting sheet 104 and the periphery of the top sheet 101, and a gap between the periphery of the connecting sheet and the periphery of the bottom sheet 102. The connecting sheet may have a thickness of 0.04 mm to 0.10 mm, for example, about 0.06 mm.

In an embodiment, a plurality of tensioning members 105 may be additionally provided. The plurality of tensioning members 105 may be uniformly arranged (in a substantially parallel manner to one another) in the inflatable chamber 106 along a long-axis length direction Y of the inflatable pad 100 and are connected to the top sheet 101 and the bottom sheet 102. This connection assists in constraining the shape of the inflatable chamber 106 after inflation and thus prevents ballooning/hyperextension of the top sheet 101 and the bottom sheet 101 from pressures arising from gasses contained within the inflatable chamber 106 of the inflatable pad 100. Put another way, the tensioning members 105 serve to maintain an approximately planar overall shape of the inflatable pad 100 when the inflatable pad 100 is in an inflated state. The tensioning members 105 may comprise the same or similar material as the top inner layer 101b of the top sheet 101 and, if a connecting sheet 104 is present, as the connecting sheet 104. For example, the tensioning member 105 may comprise a weldable material. The tensioning member 105 may comprise one or more of polyvinyl chloride (PVC), thermoplastic polyurethane elastomer (TPU), polyurethane (PU), polypropylene (PP), polyethylene (PE), polyethylene terephthalate (PET), nylon and other suitable polymer materials. Optionally, the tensioning members 105 may also comprise a fabric bonding material and/or a laminated mesh material.

In the first embodiment, particularly referring to FIG. 3, the tensioning member 105 comprises a C-shaped tensioning member. Specifically, after the inflatable chamber 106 is inflated, the tensioning member 105 comprises a main body 1053 extending substantially perpendicular to the top sheet 101 and the bottom sheet 102, and an upper connecting portion 1051 and a lower connecting portion 1052 that respectively extend from the top and the bottom of the main body 1053 on the same side of the main body 1053. The upper connecting portion 1051 and a lower connecting portion 1052 are essentially perpendicular to the main body 1053. On the cross section shown in FIG. 3, the upper connecting portion 1051, the main body 1053 and the lower connecting portion 1052 of the tensioning member 105 are integrally formed into a substantially C shape. The upper connecting portion 1051 is connected to the top sheet 101, and the lower connecting portion 1052 is connected to the bottom sheet 102.

Particularly referring to FIGS. 2A, 2B and 3-4A, a plurality of upper welding regions 107a and lower welding regions 107b of the inflatable pad 100 may comprise a plurality of substantially parallel welding lines 107 that may be respectively and uniformly arranged at an upper portion (proximate to the top sheet 101) and a lower portion (proximate the bottom sheet 102) of the inflatable pad 100 in a lengthwise direction (that is, repeatedly arranged in a substantially orthogonal direction to the long-axis direction X), or a width-wise direction (that is, repeatedly arranged in a substantially orthogonal direction to the short-axis direction Y) of the inflatable pad 100. Each welding line 107 may substantially extend in a widthwise direction (that is along the short axis Y direction) or a lengthwise direction X of the inflatable pad 100. A distance between every two adjacent welding lines 107 may be approximately equal, or in alternative embodiments, spacing between adjacent welding lines 107 may vary. At the position of each upper welding region 107a, the top inner layer 101b of the top sheet 101, which may be a polymer material layer, the connecting sheet 104, the thermal insulation layer 103, and the upper connecting portion 1051 of one tensioning member 105 are for example welded together from top to bottom by means of high-frequency welding, hot-press welding, etc. That is, the connecting sheet 104 is welded between the top sheet 101 and the thermal insulation layer 103, and the upper connecting portion 1051 of the tensioning member 105 is welded to the bottom of the thermal insulation layer 103, such that the integral-piece thermal insulation layer 103 may be firmly fixed to the top sheet 101. However, the connecting sheet 104 may also be omitted such that the thermal insulation layer 103 is directly welded to the top inner layer 101b of the top sheet 101. It can be understood that the thickness of the batting-type thermal insulation layer 103 is compressed at the positions of these welding lines 107 after welding. In the illustrated embodiments of FIGS. 3, 4, and 4A, at the illustrated welded areas of upper welding regions 107a of the inflatable pad 100, the top sheet 101, the connecting sheet 104, the thermal insulation layer 103, and the upper connecting portions 1051 of the tensioning members 105 are shown vertically spaced apart for ease of viewing, but when welded, these components are in physical contact through a welded bond. Similarly, at the illustrated welded areas of lower welding regions 107b of the inflatable pad 100, the bottom sheet 102 and the lower connecting portions 1052 of the tensioning member 105 are shown vertically spaced apart for ease of viewing, but when welded, these components are in physical contact through a welded bond. In an embodiment, the thermal insulation layer 103 may be stepped such that it comprises regions of different thickness. The tensioning members 105 may then be welded to the stepped regions of the thermal insulation layer 103 having a lower thickness. In some embodiments, the provision of the tensioning members 105 may improve the R-value of the inflatable pad 100, and accordingly, a decreased thickness of the thermal insulation layer 103 at the locations of the tensioning members 105 may not result in the formation of cold bridges or cold spots. At the position of each lower welding region 107b forming welding lines 107 at the lower portion, the lower connecting portion 1052 of the tensioning member 105 is welded to the bottom inner layer 102b of the bottom sheet 102 as shown in FIG. 4E, which may be a polymer material layer. In embodiments, a thermal insulation layer 103 may also be provided between the bottom inner layer 102b of the bottom sheet 102 and the tensioning member 105. A connecting sheet 104 placed proximate the bottom sheet 102 may further be provided. In embodiments, the plurality of tensioning members 105 may also be omitted. In embodiments, the connecting sheet 104 may also be omitted such that the thermal insulation layer 103 is directly welded to the inner side of the top and/or bottom sheet 101, 102.

In an alternative embodiment illustrated in the partial schematic perspective view of FIG. 4C, the tensioning member 105 may have one or more perforations 1054 defined within the main body 1053. The provided perforations 1054 may reduce the weight and bulk of the inflatable pad 105 without substantially impacting the ability of the tensioning members 105 to constrain the outward shape of the top sheet 101 and bottom sheet 102 when the inflatable pad 100 is in an inflated state. While the perforations 1054 are shown having elliptical or oval shapes, any desired alternative shape for the perforations 1054 may be used, including circular, square, rectangular, triangular, or any other desired shape. In one particular aspect, the perforations 1054 may assume a circular or oval shape to reduce stress risers within the main body 1053. Those of skill in the art further understand that the relative sizes of the perforations 1054 compared to the main body 1053 of the tensioning members 105 may vary depending on the desired weight, bulk, and elasticity of the tensioning members 105, as compared to the variation in deformation of the tensioning members 105 when the inflatable pad 100 assumes an inflated state.

The R-value of the inflatable pad 100 is closely related to the thickness of the thermal insulation layer 103. If the thermal insulation layer 103 is made of fibrous insulation, the R-value of the inflatable pad 100 is closely related to the thickness of the fibrous insulation. Optionally, the fibrous insulation may have a thickness of 0.5 cm to 3 cm in a natural fluffy state. Further optionally, the fibrous insulation may have a thickness of 0.8 cm to 2 cm in a natural fluffy state. The greater the thickness of the fibrous insulation, the better the effect is of preventing convection between hot air and cold air in the inflatable pad 100. A higher thermal resistance for the inflatable pad 100 correspondingly results in a larger the R-value for the inflatable pad 100.

The R-value of the inflatable pad 100 is closely related to the weight of the fibrous insulation per square meter. Optionally, the weight of the fibrous insulation placed inside the inflatable pad may be 20 g/m² to 400 g/m². Further preferably, the weight of the fibrous insulation placed inside of the inflatable pad 100 may be 80 g/m² to 160 g/m². For an inflatable pad 100 with a height of 7.5 cm after inflation, if an integral-piece fibrous insulation of 60 g/m² is used, the R-value is about 2.4 ft²·°F.·h/Btu (0.42 K·m²/W); and if an integral-piece fibrous insulation of 80 g/m² is used, the R-value is about 2.7 ft²·°F.·h/Btu (0.48 K· m²/W). It can be seen that the weight per square meter of the fibrous insulation has a significant impact on improving the R-value. If the weight per square meter of the fibrous insulation is further increased, the R-value may also rise further.

The R-value of the inflatable pad 100 is closely related to the height of the inflatable pad 100. An inflatable pad 100 of exemplary embodiments in an inflated state may have a height in a range of 2 cm to 62 cm. In one implementation, the inflatable pad 100 in an inflated state may have a height in a range of 5 cm to 18 cm. Considering an embodiment of the inflatable pad 100 with a height of 7.5 cm as described above, a thickness of the inflatable pad 100 may be further increased. A larger thickness means that the distance between the top sheet 101 and the bottom sheet 102 is longer, and more air enters the inflatable chamber 106 of the inflatable pad 100 during inflation. As is well known to those skilled in the art, air has low thermal conductivity and is a relatively poor conductor of heat. ASTM F3340-22 may be used to measure the heat flux of a vertical thickness of the inflatable pad 100 in one dimension. More air in the inflatable pad 100 means less heat flux. Heat flux is negatively related to thermal resistance, so that when the heat flux decreases, the thermal resistance increases and the R-value rises. For example, if the height of an exemplary inflatable pad 100 is doubled from 7.5 cm to 15 cm, if an integral-piece fibrous insulation of 80 g/m² is used in such an inflatable pad 100, the R-value may be improved to about 3.5 ft²·°F.·h/Btu (0.62 K·m²/W). It can be seen that the height (e.g. measured in the vertical Z direction as shown in the illustrated figures) of the inflatable pad 100 has a significant impact on improving the R-value. In sum, the R-value may rise if a height of the inflatable pad 100 increases.

### Second Embodiment

FIG. 4 shows a partial schematic cross section of a second embodiment of an inflatable pad 100, and FIG. 5 illustrates a perspective schematic exploded view of an inflatable pad 100 according to the second embodiment and components thereof.

It can be understood that the inflatable pad 100 according to the second embodiment is of a structure similar to that of the inflatable pad 100 according to the first embodiment, so that the similarity to the inflatable pad 100 according to the first embodiment may be understood with the help of the above detailed descriptions, and will not be repeated in this section.

Referring to FIGS. 4 and 5, a difference from the inflatable pad 100 according to the first embodiment is that in the inflatable pad 100 according to the second embodiment, the tensioning member 105 is a Z-shaped tensioning member 105. More particularly, after the inflatable chamber 106 is inflated, the tensioning member 105 comprises a main body 1053, and an upper connecting portion 1051 and a lower connecting portion 1052 that extend from the top and the bottom of the main body 1053 on two opposite sides of the main body 1053 respectively. In the cross section shown in FIG. 4, the upper connecting portion 1051, the main body 1053 and the lower connecting portion 1052 of the tensioning member 105 are integrally formed into a substantially Z shape. As before, the connecting sheet 104 is welded between the top sheet 101 and the thermal insulation layer 103, and the upper connecting portion 1051 of the tensioning member 105 is welded to the bottom of the thermal insulation layer 103, such that the thermal insulation layer 103 as an integral piece may be firmly fixed to the top sheet 101. However, the connecting sheet 104 may also be omitted such that the thermal insulation layer 103 is welded to the top inner layer 101b of the top sheet 101. The upper connecting portion 1051 is then connected to the top inner layer 101b of the top sheet 101, which may be a polymer material layer, together with the thermal insulation layer 103, and the lower connecting portion 1052 is connected to the bottom inner layer 102b of the bottom sheet 102, which may be a polymer material layer. In case a thermal insulation layer 103 is also provided on the bottom sheet 102, the lower connecting portion 1052 is connected to the bottom inner layer 102b of the bottom sheet 102 together with the thermal insulation layer 103. A connecting sheet 104 may also be provided between the thermal insulation layer 103 and the bottom sheet 102. The connecting sheet 104 may also be omitted. In some implementations, the main body 1053 is slightly inclined with respect to the top sheet 101 and the bottom sheet 102, i.e., the main body 1053 of the tensioning member 105 is not perpendicular to the top sheet 101 or the bottom sheet 102.

### Third Embodiment

It can be understood that the inflatable pad 100 according to a third embodiment is of a structure similar to that of the inflatable pad 100 according to the first embodiment, so that the similarity to the inflatable pad 100 according to the third embodiment may be understood with the help of the above detailed descriptions, and will not be repeated in this section.

Referring to FIG. 4A, a difference from the inflatable pad 100 according to the first embodiment is that in the inflatable pad 100 according to the third embodiment, the tensioning member 105 is formed from a continuous sheet alternately welded at the upper welding regions 107a and lower welding regions 107b, between the top sheet 101 and the bottom sheet 102, respectively. As the approximately triangular-shaped sections form a truss-like lattice between the top sheet 101 and the bottom sheet 102 of the inflatable pad 100, extra stability is provided in the X direction when the inflatable pad 100 assumes an inflated state. Additionally, manufacturing with a single-sheet tensioning member 105 may reduce complexity in assembly as a sheet may be easily dispensed from a roll to a welding apparatus interconnecting the top sheet 101 and bottom sheet 102, as compared to inserting and welding independent tensioning members 105.

### Fourth Embodiment

FIG. 6 shows a schematic exploded view (in partial cross section) of an inflatable pad 100 according to a fourth embodiment of the present disclosure and components thereof.

It can be understood that the inflatable pad 100 according to the fourth embodiment is of a structure similar to that of the inflatable pad 100 according to the first, second, and third embodiments, so that the similarity to the inflatable pad 100 according to the first, second, and third embodiments may be understood with the help of the above detailed descriptions, and will not be repeated in this section.

Referring to FIG. 6, a difference from the inflatable pad 100 according to the first embodiment is that in the inflatable pad 100 according to the fourth embodiment, the tensioning member 105 has a substantially polygonal cross section. Specifically, after the inflatable chamber 106 is inflated, the tensioning member 105 has a substantially polygonal cross sectional shape, and the substantially flat top and bottom of the tensioning member 105 form an upper connection portion 1051 and a lower connection portion 1052 of the tensioning member 105, respectively. Also differing from the first embodiment, each of the upper connecting portions 1051 and the lower connecting portions 1052 are attached to the top sheet 101 and bottom sheet 202, respectively, through two welding lines 107 each, so that each of such tensioning members 105 has four welding regions provided by the welding lines 107. Similar to the first embodiment, the upper connecting portion 1051 is welded to: a polymer material layer of a top inner layer 101b of a top sheet 101, a connecting sheet 104, and a thermal insulation layer 103 along two adjacent approximately parallel welding lines 107. The upper connecting portion 1051 is in contact with the bottom of the thermal insulation layer 103. The lower connecting portion 1052 is also welded to a polymer material layer of a bottom inner layer 102b of a bottom sheet 102 along two adjacent approximately parallel welding lines 107. As before, a thermal insulation layer 103 may also be provided on the bottom sheet 102. In embodiments, a connecting sheet 104 may also be provided proximate the bottom sheet 102. In embodiments, the connecting sheet 104 may also be omitted.

### Fifth Embodiment

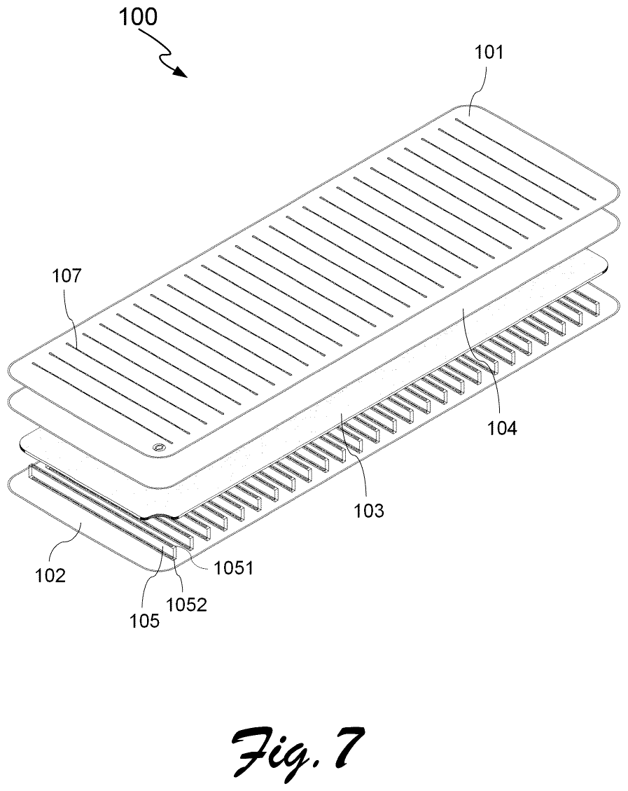

FIG. 7 shows a schematic exploded view (in partial cross section) of an inflatable pad 100 according to a fifth embodiment of the present disclosure and components thereof.

It can be understood that the inflatable pad 100 according to the fifth embodiment is of a structure similar to that of the inflatable pad 100 according to the first, second, third, and fourth embodiments, so that the similarity to the inflatable pad 100 according to the first, second, third, and fourth embodiments may be understood with the help of the above detailed descriptions, and will not be repeated in this section.

Referring to FIG. 7, a difference from the inflatable pad 100 according to the first embodiment is that in the inflatable pad 100 according to the fifth embodiment, the tensioning member 105 has a substantially polygonal cross section. Specifically, after the inflatable chamber 106 is inflated, the tensioning member 105 has a substantially polygonal cross section, and the substantially flat top and bottom of the tensioning member 105 form an upper connection portion 1051 and a lower connection portion 1052 of the tensioning member 105, respectively. Similar to the first embodiment, the upper connecting portion 1051 is welded to: a polymer material layer of a top inner layer 101b of a top sheet 101, a connecting sheet 104 and a thermal insulation layer 103 along a single welding line 107. The upper connecting portion 1051 is in contact with the bottom of the thermal insulation layer 103. The lower connecting portion 1052 is also welded to a polymer material layer of a bottom inner layer 102b of a bottom sheet 102 along a single welding line 107. Thus, each of such tensioning members 105 of the fifth embodiment has two welding regions provided by the welding lines 107. As before, a thermal insulation layer 103 may also be provided on the bottom sheet 102. In embodiments, a connecting sheet 104 may also be provided on the bottom sheet 102. In embodiments, the connecting sheet 104 may also be omitted.

It can be understood that the shape of the tensioning member 105 according to the present disclosure is not limited to the shapes described in the first to fifth embodiments. In some other implementation variants, the tensioning member 105 may also be any other tensioning members suitable for the inflatable pad 100, such as a Y-shaped tensioning member and a strand tensioning member, as long as sufficient connection strength is provided.

### Sixth Embodiment

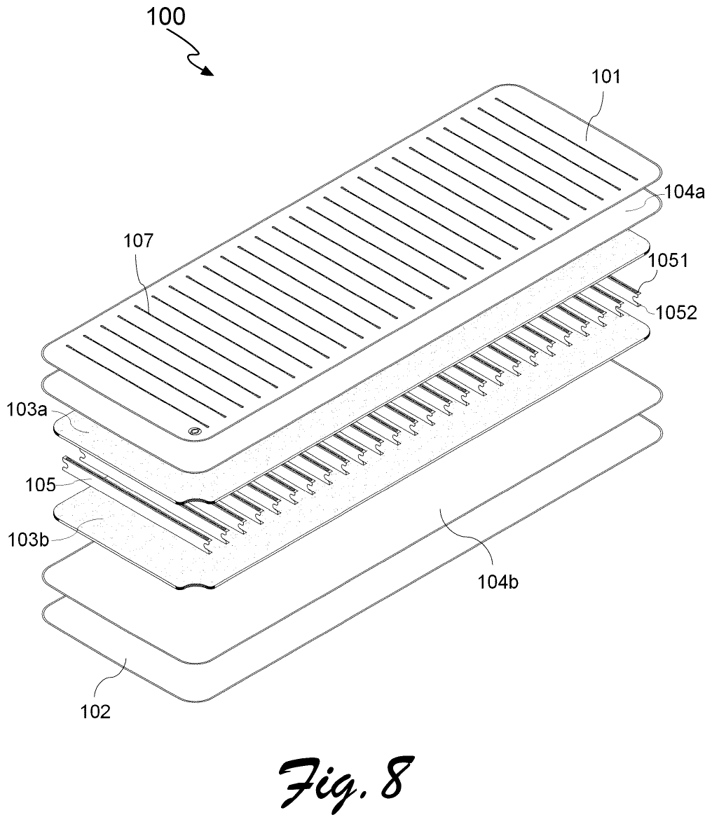

FIG. 8 shows a schematic exploded view (in partial cross section) of an inflatable pad 100 according to a sixth embodiment of the present disclosure and components thereof.

It can be understood that the inflatable pad 100 according to the sixth embodiment is of a structure similar to that of the inflatable pad 100 according to the first to fifth embodiments, so that the similarity to the inflatable pad 100 according to the first to fifth embodiments may be understood with the help of the above detailed descriptions, and will not be repeated in this section.

Referring to FIG. 8, a difference from the inflatable pad 100 according to the first embodiment is that the inflatable pad 100 according to the sixth embodiment comprises two substantially identical thermal insulation layers 103a and 103b, and two substantially identical connecting sheets 104a and 104b. More particularly, the inflatable pad 100 according to the sixth embodiment sequentially comprises a top sheet 101, a first connecting sheet 104a, a first thermal insulation layer 103a, a plurality of tensioning members 105, a second thermal insulation layer 103b, a second connecting sheet 104b, and a bottom sheet 102 from top to bottom.

At the position of each welding line 107 at the upper portion, a top inner layer 101b, which may be a polymer material layer of the top sheet 101, the first connecting sheet 104a, the first thermal insulation layer 103a, and an upper connecting portion 1051 of one tensioning member 105 are, for example, welded together from top to bottom by means of high-frequency welding, hot-press welding, etc. More particularly, a connecting sheet 104a is welded between the top sheet 101 and the first thermal insulation layer 103a, and the upper connecting portion 1051 of the tensioning member 105 is welded to the bottom of the first thermal insulation layer 103a, such that the integral-piece first thermal insulation layer 103a may be firmly affixed to the top sheet 101. At the position of each welding line 107 at the lower portion, a bottom inner layer 102b, which may be a polymer material layer of the bottom sheet 102, the second connecting sheet 104b, the second thermal insulation layer 103b, and a lower connecting portion 1052 of one tensioning member 105 are, for example, welded together from bottom to top by means of high-frequency welding, hot-press welding, etc. More particularly, a second connecting sheet 104b is welded between the bottom sheet 102 and the second thermal insulation layer 103b, and the lower connecting portion 1052 of the tensioning member 105 is welded to the top of the second thermal insulation layer 103b, such that the integral-piece second thermal insulation layer 103b may be firmly fixed to the bottom sheet 102. It can be understood that the thicknesses of the batting-type first thermal insulation layer 103a and the batting-type second thermal insulation layer 103b are compressed at the positions of these welding lines 107 after welding. As before, the plurality of tensioning members 105 may also be omitted.

### Seventh Embodiment

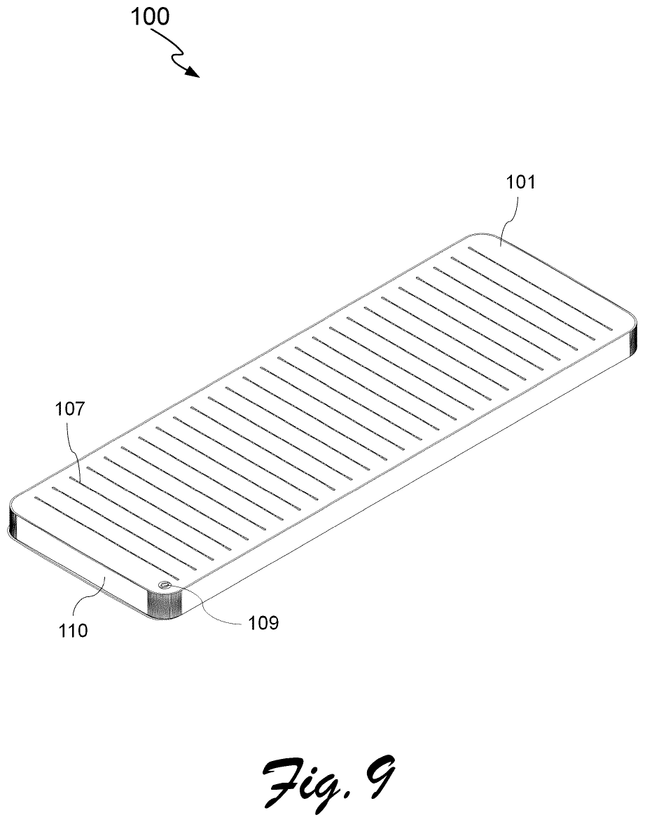

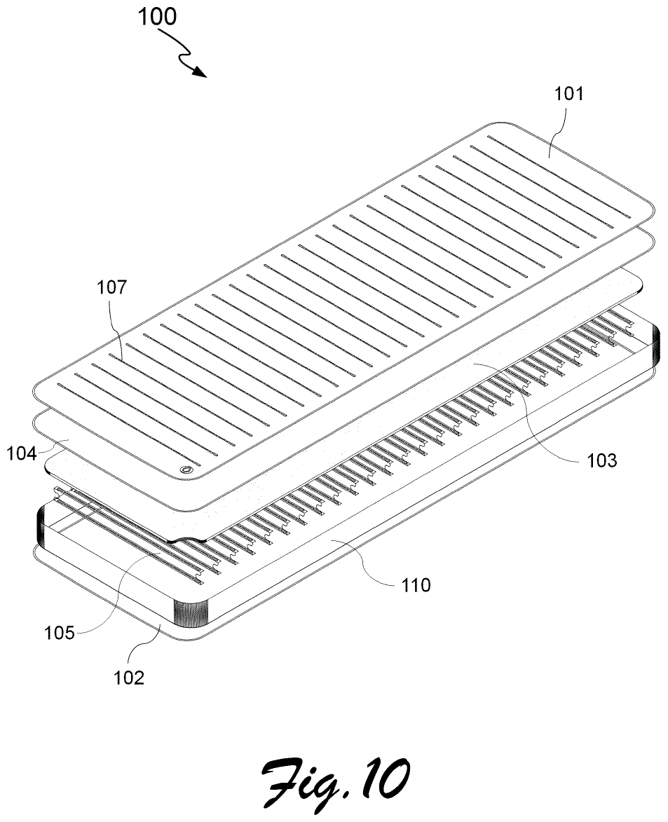

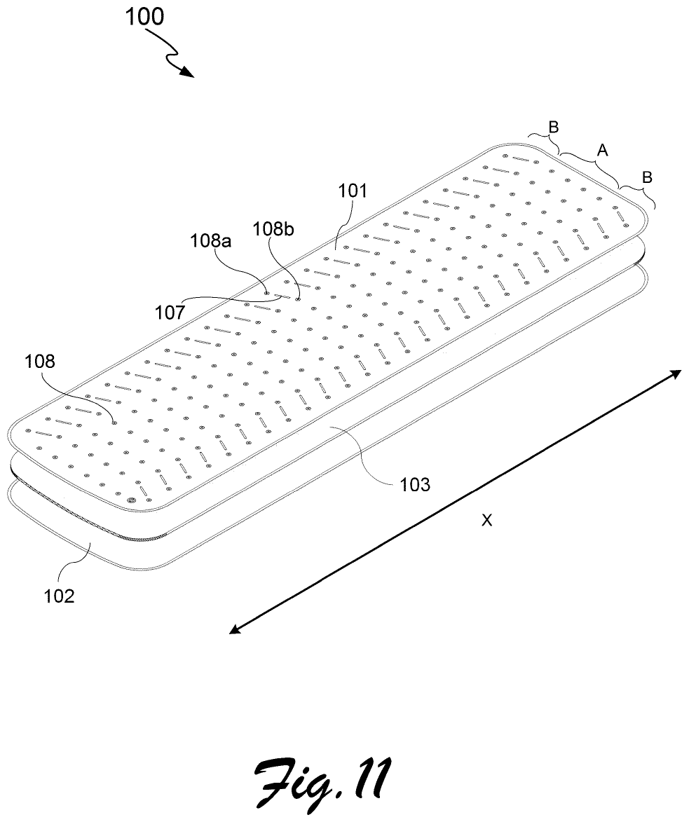

FIG. 9 and FIG. 10 show schematic perspective and exploded views of an inflatable pad 100 according to a seventh embodiment of the present disclosure and components thereof.

It can be understood that the inflatable pad 100 according to the seventh embodiment is of a structure similar to that of the inflatable pad 100 according to the first to sixth embodiments, so that the similarity to the inflatable pad 100 according to the first to sixth embodiments may be understood with the help of the above detailed descriptions, and will not be repeated in this section.

Referring to FIG. 9 and FIG. 10, a difference from the inflatable pad 100 according to the first embodiment is that the inflatable pad 100 according to the seventh embodiment further comprises side wall 110 (also referred to herein as a lateral confining sheet 110). The periphery of the top sheet 101 and the periphery of the bottom sheet 102 may be connected by means of the side wall 110. Specifically, the periphery of the top sheet 101 may be welded to a top edge of the side wall 110, and the periphery of the bottom sheet 102 may be welded to a bottom edge of the side wall 110, so that the top sheet 101, the bottom sheet 102 and the side wall 110 jointly define the inflatable chamber 106. An air valve 109 may be welded to the top sheet 101, the bottom sheet 102, or to the side wall 110.

For example, the side wall 110 may comprise the same material as the top sheet 101 or bottom sheet 102. For example, the side wall 110 may comprise an outer layer facing outside of the inflatable chamber 106 and an inner layer facing inside of the inflatable chamber 106. In an embodiment, the outer layer may be a fabric layer, and the inner layer may be made of weldable material. The inner layer may be a polymer material layer. For example, the inner layer of the side wall 110 may be made of one or a combination of more than one of polyvinyl chloride (PVC), thermoplastic polyurethane elastomer (TPU), polyurethane (PU), polypropylene (PP), polyethylene (PE), polyethylene terephthalate (PET), polyamide (PA), nylon and other suitable polymer materials.

It can be understood that the embodiments described above are not exhaustive, and on the basis of the disclosure of the first to seventh embodiments, the present disclosure also covers various implementation variants readily conceivable to those skilled in the art.

For example, according to an implementation variant not illustrated, the inflatable pad 100 may comprise only a single thermal insulation layer 103 fixed to the bottom sheet 102, i.e., may comprise only the second thermal insulation layer 103b according to the sixth embodiment but not the first thermal insulation layer 103a.

In addition, according to some other implementation variants, regardless of whether the inflatable pad 100 comprises a single thermal insulation layer 103 as in the first, second, third, fourth, fifth, and seventh embodiments or two thermal insulation layers 103 as in the sixth embodiment, there may be no connecting sheet 104 between the thermal insulation layer 103 and the top sheet 101 or the bottom sheet 102. More particularly, the thermal insulation layer 103 may be directly welded to a top inner layer 101b of the top sheet 101, which may be a polymer material layer, or a bottom inner layer 102b, which may be a polymer material layer of the bottom sheet 102. The top inner layer 101b of the top sheet 101 welded to the thermal insulation layer 103 may have a thickness of 0.08 mm to 0.28 mm. The bottom inner layer 102b of the bottom sheet 102 welded to the thermal insulation layer 103 may have a thickness of 0.08 mm to 0.28 mm.

In addition, according to some other implementation variants, in addition to the thermal insulation layer 103, the inflatable pad 100 may further comprise at least one other thermal insulation layer, which is arranged in the inflatable chamber 106 and through which for example the tensioning member 105 passes. The at least one other thermal insulation layer may be made of the same material as the thermal insulation layer 103, and may also be made of any other suitable thermal insulation materials.

### Eighth Embodiment

FIG. 4B shows a partial cross section of an inflatable pad 100 according to an eighth embodiment and components thereof.

In this eighth embodiment, a difference from the inflatable pad 100 according to the first embodiment is that in the inflatable pad 100 according to the eighth embodiment, upper connecting portions 1051 of the tensioning members 105 are welded to the connecting sheet 104 at points 107c, optionally with or without an intervening thermal insulation layer 103 disposed between the upper connecting portions 1051 of the tensioning members 105 and the connecting sheet 104; in the illustrated embodiment no such intervening thermal insulation layer 103 is shown. However, in this eighth embodiment, neither the upper connecting portions 1051 of the tensioning members 105, nor the thermal insulation layer 103 are welded to the top sheet 101 in a centrally-located welding line 107. Instead, in this embodiment, a thermal insulation layer 103 is disposed between the connecting sheet 104 and a top sheet 101, and a proximate peripheral weld zone 107d (not shown directly in FIG. 4B, but disposed proximate edge areas 100c of inflatable pad 100) secures the top sheet 101 and the thermal insulating layer 103 together, and the top sheet 101 to the connecting sheet 104, thereby enclosing the thermal insulation layer 103 between the connecting sheet 104 and the top sheet 101. The lower connecting portions 1052 of the tensioning members 105 are welded to the bottom sheet 102 at lower welding regions 107b. Further, in this embodiment, the cavity that encloses such thermal insulation layer 103 is not in fluid communication with the inflatable chamber 106, but instead may also include one or more perforations in the top sheet 101 to allow the enclosed area formed by the top sheet 101 and the connecting sheet 104 of the inflatable pad 100 to be degassed when the inflatable pad 110 is folded and/or rolled for storage.

In the configuration provided by the eighth embodiment, the thermal insulation layer 103 is not welded (and thus not compressed) in its central sections by transverse welding lines 107, being welded and/or affixed only at distal edge areas 100c proximate peripheral weld areas 107d, and the thermal insulation layer assumes its maximal fluff thickness to provide optimal thermal insulation. Further, in this eighth embodiment, as the tensioning members 105 are not directly attached to the top sheet 101 or thermal insulation layer 103, thermal conduction between the bottom sheet 102 and the top sheet 101 is further inhibited, providing for improved thermal resistance and R-rating, and improved user comfort.

### Ninth Embodiment

FIG. 11 shows an inflatable pad 100 according to a ninth embodiment of the present disclosure and components thereof.

It can be understood that the inflatable pad 100 according to the ninth embodiment is of a structure similar to that of the inflatable pad 100 according to the first embodiment, so that the similarity to the inflatable pad 100 according to the first embodiment may be understood with the help of the above detailed descriptions, and will not be repeated in this section.

Referring to FIG. 11, a difference from the inflatable pad 100 according to the first to seventh embodiment is that the inflatable pad 100 according to the ninth embodiment only comprises a top sheet 101, a bottom sheet 102 and a thermal insulation layer 103, but not a connecting sheet 104 or any tensioning members 105. In addition, in the ninth embodiment, a plurality of welding regions of the inflatable pad 100 comprise a plurality of welding points 108 and a plurality of welding lines 107 distributed uniformly.

More particularly, the inflatable pad 100 comprises a central region A extending through the central portion of the inflatable pad 100 along a long axis direction X and two edge regions B located at two sides of the central region A. The central region A is provided with a plurality of welding points 108. These welding points 108 may be arranged in a uniform array. Each of the two edge regions B may be provided with a plurality of welding lines 107 that are disposed in a manner parallel to each other, each of the welding lines flanked by respective welding points 108a, 108b. More particularly, an outer welding point 108a may be arranged adjacent to a side edge of the inflatable pad 100 and at a predetermined distance from a first end of each welding line 107. A respective inner welding point 108b may be arranged at a predetermined distance from a second end of each welding line 107. Such arrangement increases the connection firmness of two ends of the welding line 107, thus ensuring the flatness of the inflatable pad 100 and improving the overall use effect of the inflatable pad 100. It can be understood that neither the shape nor the specific arrangement of the welding region is limited in the present disclosure. The welding region of the inflatable pad 100 according to the ninth embodiment may also comprise only the welding lines 107 but not the welding points 108, 108a, 108b. In such an embodiment, the welding region B, A, B according to the ninth embodiment may be provided as a plurality of welding lines 107 that are uniformly arranged and parallel to each other as in the first to seventh embodiments. Furthermore, according to some implementation variants, a plurality of welding regions of the inflatable pad 100 may for example comprise only a plurality of welding points 108 arranged in a uniform array but not the welding lines 107.

In the ninth embodiment, a top inner layer 101b, which may be a polymer material layer of the top sheet 101, the single thermal insulation layer 103, and a bottom inner layer 102b, which may be a polymer material layer of the bottom sheet 102 are, for example, welded together from top to bottom along welding points 108, 108a, 108b and welding lines 107 by means of high-frequency welding, hot-press welding, etc. That is, the top of the thermal insulation layer 103 is directly welded to the top inner layer 101b of the top sheet 101, and the bottom of the thermal insulation layer 103 is directly welded to the bottom inner layer 102b of the bottom sheet 102, so that the integral-piece thermal insulation layer 103 may be firmly fixed to the top sheet 101 and the bottom sheet 102, and the thickness of the batting-type thermal insulation layer 103 is compressed at these welding points 108 and these welding lines 107 after welding.

Since the connecting sheet 104 is not provided in the ninth embodiment, the thickness of each of the top sheet 101 and the bottom sheet 102 may be selected to be greater than that of the top sheet 101 or the bottom sheet 102 in the first to seventh embodiments. For example, in the ninth embodiment, the top inner layer 101b of the top sheet 101 and the bottom inner layer 102b of the bottom sheet 102 may each have a thickness of 0.08 mm to 0.28 mm. However, in the first to seventh embodiments, when the connecting sheet 104 is provided, the top inner layer 101b of the top sheet 101 and the bottom inner layer 102b of the bottom sheet 102 may each have a thickness of 0.04 mm to 0.18 mm, for example, about 0.06 mm. The connecting sheet 104 may have a thickness of 0.04 mm to 0.10 mm, for example, about 0.06 mm.

Based on the above embodiments, it can be known that compared with the inflatable pad using small pieces of fibrous insulation in the prior art, the inflatable pad 100 according to the present disclosure offers improvements in that the batting-type integral-piece thermal insulation layer 103 is arranged in the inflatable chamber 106 formed by the top sheet 101 and the bottom sheet 102. The integral-piece thermal insulation layer 103 may be connected to the top sheet 101 or the bottom sheet 102, or two integral-piece thermal insulation layers 103 connected to the top sheet 101 and the bottom sheet 102 respectively may also be provided. In the inflatable pad 100 according to the present disclosure, the thermal insulation performance of the inflatable pad 100 is enhanced, heat convection between the top and the bottom of the inflatable pad 100 is reduced, and the R-value is improved. Also, in an alternative embodiment, a batting-type integral piece thermal insulation layer 103 may be disposed between the top sheet 101 and connecting sheet 104, without use of central weld points or welding lines in such thermal insulation layer 103, and the inflatable chamber 106 is enclosed within the connecting sheet 104 and the bottom sheet 102. In this alternative embodiment, the thermal insulation layer 103 achieves maximal fluff and thermal resistance, and additionally improved R-value.

Furthermore, compared with an inflatable pad using small pieces of fibrous insulation in the prior art, according to present embodiments, the thermal insulation layer 103 may be fixed more firmly and thus is less likely to fall off, and for example may be directly connected to the top sheet 101 and the bottom sheet 102 of the product by means of high-frequency welding, hot-press welding, etc., without cutting the fibrous insulation or making holes in the fibrous insulation and without attaching the fibrous insulation onto the top sheet 101 or the bottom sheet 102 by glue. The inflatable pad 100 according to the present disclosure has fewer manufacturing processes, and is high in manufacturing efficiency, low in labor cost and short in production time.

It can be understood that the welding methods mentioned in the description comprise high-frequency welding, hot-press welding and any other suitable welding methods.

It can also be understood that the components and features described herein can be made of various other materials including, but not limited to, polymer, rubber, metal, and other suitable materials well known to those skilled in the art or a combination thereof. The described and illustrated embodiments only show the shapes, dimensions and arrangements of various optional components of the inflatable pad according to the present disclosure, which are merely illustrative but not limiting, and other shapes, dimensions and arrangements may be employed without departing from the spirit and scope of the present disclosure. Those skilled in the art can easily make modifications, variations, and equivalents of these embodiments on the basis of the disclosed content. For example, the illustrated or described features as part of an embodiment can be used with another embodiment to provide a further embodiment. The present disclosure is intended to cover these modifications, variations, and equivalents.

The technical content and technical features of the present disclosure are disclosed above, but it should be understood that those skilled in the art can make various variations and improvements to the concepts disclosed above under the inventive idea of the present disclosure, and all the variations and improvements fall within the scope of protection of the present disclosure. The description of the above implementations is illustrative rather than restrictive, and the scope of protection of the present disclosure is determined by the claims.

What is claimed is:

1. An inflatable pad, which comprises:
a top sheet;
a bottom sheet connected to the top sheet to jointly define an inflatable chamber;
an air valve disposed on the top sheet; and
at least one thermal insulation layer arranged between the top sheet and the bottom sheet,
wherein each of the at least one thermal insulation layer is an integral-piece batting-type sheet material, and is arranged between the top sheet and the bottom sheet, and welded to at least one of the top sheet and the bottom sheet along one or more welding regions.

2. The inflatable pad according to claim 1, wherein at least one of the top sheet and the bottom sheet comprises an outer layer facing away from the inflatable chamber and an inner layer facing towards the inflatable chamber, the outer layer being a fabric layer, and the inner layer being made of a polymer material.

3. The inflatable pad according to claim 2, wherein the fabric layer comprises cotton fiber, wool fiber, silk fiber, hemp fiber, regenerated fiber, polyester fiber, polyamide fiber, polyacrylonitrile fiber, polyvinyl alcohol fiber, polypropylene fiber, polyurethane fiber, or inorganic fiber.

4. The inflatable pad according to claim 2, wherein the polymer material comprises one or more of polyvinyl chloride, thermoplastic polyurethane elastomer, polyurethane, polypropylene, polyethylene, polyethylene terephthalate, polyamide, or nylon.

5. The inflatable pad according to claim 1, wherein the at least one thermal insulation layer is made of one or more of insulating fiber, cotton fiber, wool fiber, viscose fiber, acetate fiber, polyester fiber, polyamide fiber, polyacrylonitrile fiber, polyvinyl alcohol fiber, polypropylene fiber, or polyurethane fiber.

6. The inflatable pad according to claim 1, wherein the inflatable pad further comprises at least one connecting sheet, the connecting sheet being arranged in the inflatable chamber and welded between the top sheet and the at least one thermal insulation layer or between the bottom sheet and the at least one thermal insulation layer along the one or more welding regions.

7. The inflatable pad according to claim 6, wherein the connecting sheet is made of at least one of:
polyvinyl chloride, thermoplastic polyurethane elastomer, polyurethane, polypropylene, polyethylene, polyethylene terephthalate, polyamide, or nylon;
a fabric bonding material; or
a laminated mesh material.

8. The inflatable pad according to claim 6, wherein the connecting sheet has a thickness of 0.04 mm to 0.10 mm, and the top sheet and/or the bottom sheet comprise(s) a polymer material layer welded to the connecting sheet, the polymer material layer of the top sheet and/or the bottom sheet having a thickness of 0.04 mm to 0.18 mm.

9. The inflatable pad according to claim 1, wherein the inflatable pad further comprises one or more tensioning members connecting the top sheet to the bottom sheet, the one or more tensioning members each being welded to the at least one thermal insulation layer and the top sheet and/or the bottom sheet along the one or more welding regions.

10. The inflatable pad according to claim 9, wherein each of the one or more tensioning members comprises polyvinyl chloride, thermoplastic polyurethane elastomer, polyurethane, polypropylene, polyethylene, polyethylene terephthalate, polyamide, or nylon, or a fabric bonding material or a laminated mesh material.

11. The inflatable pad according to claim 9, wherein the inflatable pad further comprises a connecting sheet, the connecting sheet being arranged between the top sheet and the at least one thermal insulation layer and/or between the bottom sheet and the at least one thermal insulation layer so that the at least one thermal insulation layer is welded between the connecting sheet and the one or more tensioning members.

12. The inflatable pad according to claim 9, wherein the one or more tensioning members comprise one or more of:
a C-shaped cross-sectional profile;
a Z-shaped cross-sectional profile;
a continuous truss-shaped cross-sectional profile;
a polygonal cross-sectional profile having two welding regions;
a polygonal cross-sectional profile having four welding regions; and
a main body including one or more perforations.

13. The inflatable pad according to claim 1, wherein the inflatable pad further comprises a side wall, a periphery of the top sheet is connected to a top edge of the side wall, and a periphery of the bottom sheet is connected to a bottom edge of the side wall, such that the top sheet, the bottom sheet and the side wall jointly define the inflatable chamber.

14. The inflatable pad according to claim 1, wherein the one or more welding regions comprises a plurality of welding points and/or a plurality of welding lines distributed uniformly.

15. The inflatable pad according to claim 1, wherein the inflatable pad comprises a single thermal insulation layer, the single thermal insulation layer being directly welded to the top sheet and the bottom sheet.

16. The inflatable pad according to claim 15, wherein each of the top sheet and the bottom sheet comprises a polymer material layer welded to the single thermal insulation layer, the polymer material layer of the top sheet and the bottom sheet having a thickness of 0.08 mm to 0.28 mm.

17. The inflatable pad according to claim 1, wherein the inflatable pad comprises a first thermal insulation layer welded to the top sheet and a second thermal insulation layer welded to the bottom sheet.

18. The inflatable pad according to claim 1, wherein the inflatable pad in an inflated state has a height in the range of 2 cm to 62 cm.

19. The inflatable pad according to claim 1, wherein the thermal insulation layer
has a weight in the range of 80 g/m² to 160 g/m², and/or
has a thickness in the range of 0.5 cm to 3 cm in a natural fluffy state.

20. An inflatable pad, which comprises:
a top sheet;
a bottom sheet;
a connecting sheet arranged between the top sheet and the bottom sheet;
a thermal insulation layer arranged between the top sheet and the connecting sheet, wherein the thermal insulation layer is an integral-piece batting-type sheet material;
one or more tensioning members connecting the connecting sheet to the bottom sheet, each of the plurality of tensioning members being welded to the connecting sheet and the bottom sheet along a plurality of welding regions; and
wherein:
the bottom sheet is connected to the connecting sheet proximate the peripheral weld zone to jointly define an inflatable chamber, an air valve further provided in fluid communication with the inflatable chamber to allow for inflation or deflation thereof.
